(19) United States
(12) Patent Application Publication
(10) Pub. No.: US 2006/0111032 A1
(43) Pub. Date: May 25, 2006

(54) Finishing tool

(76) Inventors: Jeffrey Weston, Jackson, TN (US); Paul Todd, Doncaster (GB); David N. Johnson, Doncaster (GB); Jeremy Lowder, Shelbyville, KY (US); Sajid Ahmed Roomy Mastan, Louisville, KY (US)

Correspondence Address: HARNESS, DICKEY & PIERCE, P.L.C., P.O. BOX 828, BLOOMFIELD HILLS, MI, 48303, US

(21) Appl. No.: 11/270,880

(22) Filed: Nov. 9, 2005

Related U.S. Application Data
(60) Provisional application No. 60/626,218, filed on Nov. 9, 2004.

(51) Int. Cl. B23F 21/03

(52) U.S. Cl. 451/557

(57) ABSTRACT

A device for finishing a surface includes a body member with a contoured exterior surface and adapted to couple with a shaft. At least two surface portions, positioned at different radial distances from an axis of the body member, define the contoured exterior surface. Each surface portion includes an abrasive member to finish a surface. In another aspect, a device for finishing a surface includes a body portion with an exterior surface configured to finish a surface formed by a rotary cutter. The exterior surface has a profile that substantially corresponds to a profile of a surface formed by the rotary cutter. A coupling member is coupled to the body portion and adapted to be coupled to a rotary drive mechanism to transmit rotational energy to the body portion.

### CROSS-REFERENCE TO RELATED APPLICATION

This application claims the benefit of U.S. Provisional Application No. 60/626,218, filed on Nov. 9, 2004. The disclosure of the above application is incorporated herein by reference.

### TECHINCAL FIELD

This application relates to a tool for finishing a surface, for example, by sanding, smoothing, abrading or polishing a workpiece surface such as a wood surface with a contoured profile. In an embodiment, the tool includes an exterior surface with a profile that is conformed with or inverse to the profile of the workpiece surface.

### BACKGROUND

Various types of rotary machines with rotating output shafts, such as routers, wood shapers, planers, moulders, table saws, and computerized numerically controlled (CNC) machine tools, are used to cut slots and dados, and/or to mold edges of workpieces such as wood stock. Interchangeable working tools, bits, or cutters are attached to the rotatable shafts. Such bits come in a variety of shapes and profiles suited for a particular kind of material or removal. For example, FIG. 2B illustrates a rotary cutter 70 that includes a shank portion 72 and a cutting head 74 having a profile designed to cut an inverse profile into a workpiece. Cutting head 74 is coupled to shank 72 with a fastener 78 and includes a roller bearing 76. Many other shapes and profiles of cutting heads are available.

Although the rotatable machines, such as routers, have significantly increased the ease and quality of cuts into the workpiece, the ability to finish the workpiece, having these intricate cuts or edges, is limited. Typically, the work cut by the rotary machines is finished by hand sanding. This technique is often unsatisfactory for intricate cuts, such as molding cuts. For instance, edge forming router bits may create molding with multiple beads and fillets. Hand sanding of such work is not only tedious, because the user cannot access all surfaces of the wood simultaneously, but in most case, is problematic since access to certain surface, such as the fillets, may be severely limited. Further, even if the user is capable of sanding all surfaces, the sanding may not be uniform due to the user applying more pressure in one area than another.

In order to decrease the user fatigue and in an attempt to lessen the time required to sand the workpiece, motorized sanders have been used. However, these sanders still face the limitations of not being able to access all areas evenly.

### SUMMARY

In accordance with a first aspect, a device for finishing a surface includes a body member having a contoured exterior surface and a central axis. The body member is adapted to be coupled to a shaft. At least two surface portions define the contoured exterior surface. The at least two surface portions are positioned at different radial distances from the axis. Each surface portion includes an abrasive portion.

Embodiments of this aspect may include one or more of the following features. The body member is toroidal shaped. The body member includes a central bore adapted to be coupled to the shaft. The body member may include a rigid or semi-rigid material. The rigid or semi-rigid material is comprises one or more of the following materials: foam, metal fiber, composite fiber, plastics, felt, rubber, and polymers. The abrasive member includes an abrasive grit coupled to the body member, e.g., by being impregnated in the body member. The body member includes one or more slots and the abrasive member includes one or more flexible abrasive flaps received in the one or more slots.

In accordance with a second aspect, a device for finishing a surface includes a body portion having an exterior surface configured to finish a surface formed by a rotary cutter. The body portion exterior surface has a profile that substantially corresponds to a profile of the surface cut by the rotary cutter. A coupling member is coupled to the body portion and is adapted to be coupled to a rotary drive mechanism to transmit rotary energy to the body portion.

Embodiments of this aspect may include one or more of the following features. The body portion has a profile which is substantially inverse to the profile of the cut surface. The body portion further includes an abrasive material on the exterior surface. The abrasive material is semi-rigid. The abrasive material is coupled to an underlining substrate such as foam. The body portion may include one or more channels configured to facilitate debris removal from the surface. The body may include one or more slots configured to receive one or more abrasive elements. The body portion is configured to sand, abrade, polish or smooth the cut surface. The body may be formed from a rigid material. The body portion may be unitarily formed with the shaft. The coupling member includes a locking mechanism, e.g., a bore with at least one key way, to couple with a shaft of rotary drive mechanism. In an embodiment, the at least one key way may have a plurality of key ways that form a spline pattern in the bore. In another embodiment, the locking mechanism may include a key way with a helical configuration. In yet another embodiment, the locking mechanism may include one or more ribs or slots to receive ribs. The device may further include a drive tool that has a shaft with at least one key to mate with the bore key way. The drive tool has a shank to couple it with the rotary device such as a router or drill. The bore may couple with an arbor of a table saw. Also, the shaft may have more than one shank portion such that the shanks may be coupled with a planer or moulder.

According to a third aspect, a device for cutting and finishing a surface includes a body portion having a cutting member. The cutting member has a desired configuration to form a cut profile in a workpiece. A finishing member is associated with the body portion. The finishing member has a desired configuration substantially similar to the cutting member to finish the cut profile in the workpiece. A coupling member is coupled with the body portion and is adapted to be coupled to rotary drive mechanism.

Embodiments of this aspect may include one or more of the following features. The cutting member includes at least two cutting blades. The cutting blades each have a profile that is substantially inverse to the desired profile cut into the workpiece. The finishing member comprises one or more abrasive surfaces positioned between the cutting blades. The abrasive surface has an outer diameter that is less than an outer diameter of the cutting blade.

According to a fourth aspect, a method of forming a surface of a desired profile includes cutting a desired profile into a surface of a workpiece using a first rotary tool coupled to a cutting device. The cutting device has a profile that is substantially inverse to the desired profile of the surface. The profiled surface of the workpiece is finished using a second rotary tool coupled to a finishing element. The finishing element has a profile that is substantially inverse to the desired profile of the surface of the workpiece.

Embodiments of this aspect may include one or more of the following features. The first rotary tool may be a router and the second rotary tool may be a drill. The first cutting device may be a router bit and the finishing device may be a finishing bit. The first and second tools may be the same.

According to a fifth aspect, a kit includes a rotary cutting tool for cutting a profile in a surface of a workpiece and a finishing tool having a finishing element configured to finish the surface of the workpiece formed using the cutting tool. The finishing element has a profile that substantially corresponds to a profile of the surface of the workpiece. A coupling member is coupled with the body portion and is adapted to be coupled to a rotary drive tool to transmit rotary energy to the body portion.

Further features and areas of applicability will become apparent from the detailed description provided hereinafter and from the claims. It should be understood that the detailed description and specific examples, while including one or more embodiments, are intended for purposes of illustration only and are not intended to limit the scope of the claims that follow.

### BRIEF DESCRIPTION OF THE DRAWINGS

FIG. 1 is a perspective view of an embodiment of a finishing tool.

FIG. 2 is an exploded view of the finishing tool of FIG. 1.

FIG. 2A is an exploded view of an alternative embodiment of a finishing tool.

FIG. 2B is a perspective view of an embodiment of a cutting tool.

FIGS. 2C-21 are side views of other embodiments of finishing tools.

FIG. 3A is a perspective view of the finishing tool of FIG. 1 coupled to a router.

FIG. 3B is a side view of a finishing tool coupled to a wood shaper.

FIG. 4 is a perspective view of the finishing tool of FIG. 1 coupled to a drill.

FIG. 5 is a perspective view of an alternate embodiment of a finishing tool including a debris channel.

FIG. 6 is a perspective view of an alternate embodiment of a finishing tool with slots to receive abrasive members.

FIG. 7 is a side view of an alternate embodiment of a finishing tool with a cutter and an abrasive surface.

FIG. 8 is a side view an alternate embodiment of a finishing tool with a rigid body member.

FIG. 9A is a perspective view of an alternate embodiment of a finishing tool on a table saw.

FIG. 9B shows a cross-section of the finishing tool of FIG. 9A.

FIG. 10 is a perspective view of alternate embodiment of a finishing tool on a planer or moulder.

### DETAILED DESCRIPTION OF THE DRAWINGS

The following description is merely exemplary in nature and is in no way intended to limit the scope of the claims.

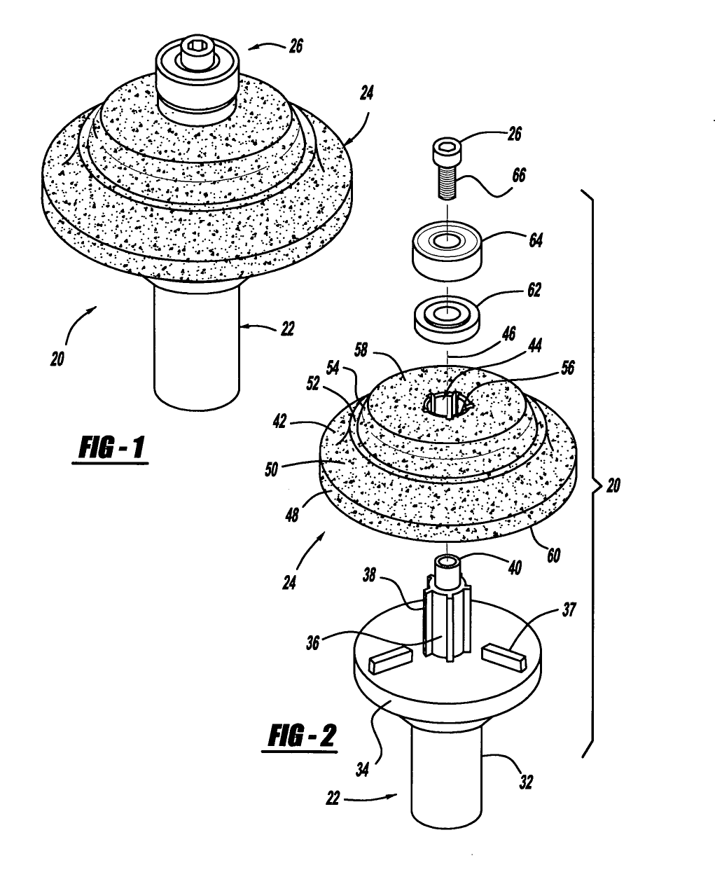

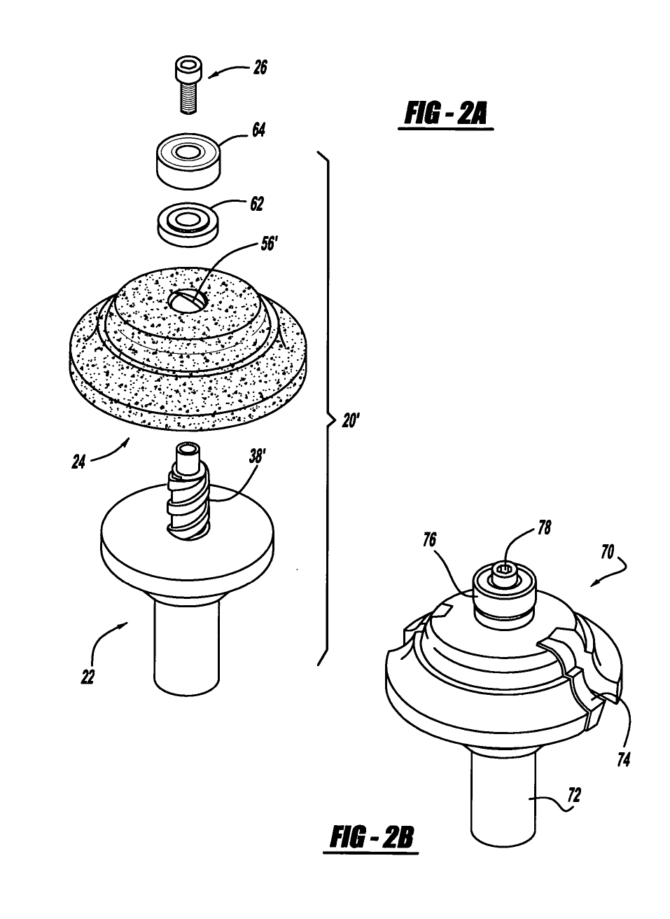

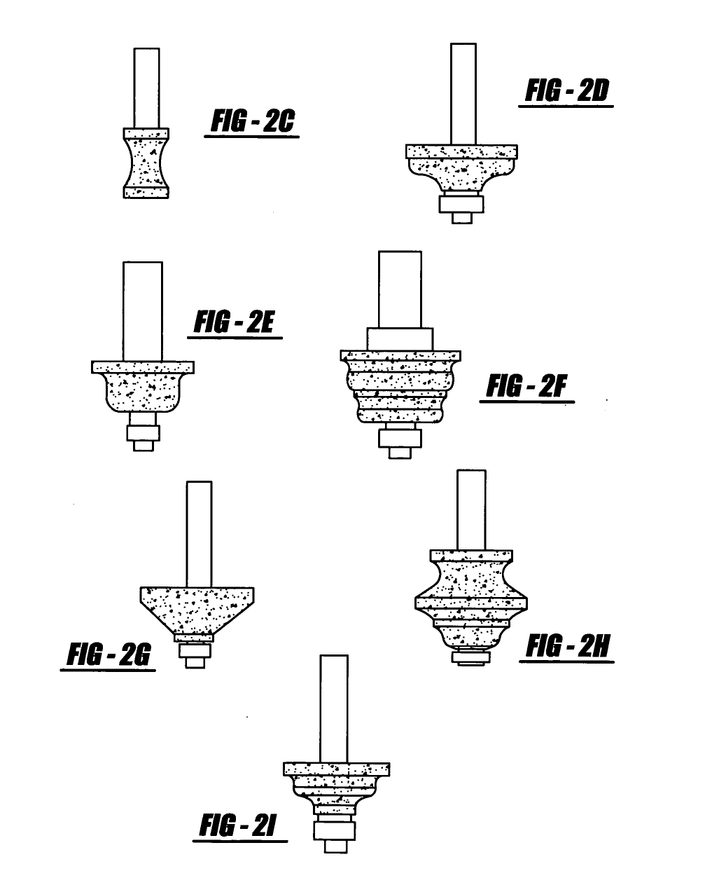

Referring to FIGS. 1 and 2, in a first embodiment, a finishing device 20 includes a tool drive shaft 22 coupled with a finishing element 24. The finishing element 24 is configured to finish a surface that has been formed by use of a rotary cutter, such as the rotary cutter 70 shown in FIG. 2B, by e.g., sanding, abrading, polishing and/or smoothing the surface. The finishing element 24 has an exterior surface 42 with a profile that is substantially the same as the profile of the rotary cutter 70 and that is substantially the inverse of the profile of the surface formed by the rotary cutter 70. Alternatively, multiple finishing tools could be used. Here, each tool would finish a portion of the profile surface.

In the embodiment shown in FIGS. 1 and 2, finishing element 24 has, e.g., a generally toroidal shape, with a longitudinal axis 46. Exterior surface 42 includes a plurality of surfaces 48-54 continuous with one another and spaced at different radial distances from the longitudinal axis 46. The surfaces 48-54 define the outer contour or profile of the exterior surface 42. Surfaces 48-54 may be, e.g., planar, concave, convex, or skewed, depending upon the shape of the cutter bit to which the finishing element corresponds. The finishing element can have a myriad of different shapes and sizes with a greater or fewer number of exterior surfaces and with surface(s) having different shapes and profiles as shown, for example, in FIGS. 2C-2I.

FIG. 2C illustrates a finishing tool with a single concave surface with planar ends forming the profiled surface, without a roller bearing. FIG. 2D illustrates a finishing tool with a planar, convex and concave surface portions, forming the profile surface, as well as a roller bearing. FIG. 2E illustrates a finishing tool with a plurality of surfaces portions including a planar surface portion, concave surface portion, and convex surface portion, forming the profile surface. FIG. 2F illustrates a finishing tool having a plurality of surface portions with a planar, concave convex, planar, concave, convex, surface portions to form the profile surface. Also, the tool includes a roller bearing. FIG. 2G illustrates a finishing tool with a planar and right conical surface portion forming the profile surface as well as a roller bearing. FIG. 2H illustrates a finishing tool with a planar, concave, convex, planar, concave planar, convex, surface portions forming the profile surface. It also includes a roller bearing. FIG. 2I illustrates a finishing tool with a plurality of surface portions with a planar, concave, convex, concave, surface portions forming the profile surface as well as a roller bearing. Further, the finishing element can have only a single surface or multiple surfaces having a wide variety of shapes. In addition, the shape of the finishing element may, but need not, correspond precisely to the contour of the corresponding cutting element or the surface to be finished. Rather, the finishing element may have a similar profile with a larger or smaller size or may have a different profile altogether.

One or more of the plurality of exterior surfaces 48-54 includes an abrasive material to finish the surface, e.g., by sanding, abrading, polishing and/or smoothing. In one embodiment, the finishing element 24 is formed of a rigid or semi-rigid material, such as foam, metal fiber, composite fiber, plastic, felt, rubber, polymers, or a combination of these. The material may, e.g., provide enough rigidity so that the finishing member holds it shape while finishing a surface, and enough flexibility to enable the finishing element 24 to finish the intricate cuts, edges, beads and fillets formed by a cutting member. An abrasive material, such as particulate grit, may be adhered to the exterior surface 42 and/or impregnated into the rigid or semi-rigid material. The grit may include one or more sizes (such as 80, 120, or 220) capable of finishing different surfaces to different fineness. In another embodiment, the abrasive material is a substrate such as a paper or cloth bonded to the exterior surface 42, e.g., using an adhesive such that the abrasive material can be applied and removed to the exterior surface as needed.

The finishing element 24 may be fixedly coupled to a tool drive 22, e.g., by being integral with tool drive 22 or welded to tool drive 22, or may be removably coupled to tool drive 22. In the embodiment shown in FIG. 2, tool drive 22 includes a shank 32 to secure the tool drive into a rotary drive such as a router or a drill. A dividing member 34 is continuous with the shank 32. The dividing member 34 provides an annular planar surface to receive the finishing element 24. A shaft 36 projects from the dividing member 34. The shaft 36 includes a locking mechanism, e.g., one or more keys 38 projecting from the shaft 36 and/or one or more radial keys 37. The keys 38 have a desired cross-sectional configuration, e.g., rectangular, which acts to retain the finishing element 24 against rotation while it is on the drive tool 22. When a plurality of keys are present, as shown in FIG. 2, the keys act as splines to receive the finishing element 24. The terminus of the shaft 36 includes a threaded bore 40 which receives the fastener 26 to secure the finishing element 24 onto the drive tool 22.

The finishing element 24 includes a corresponding locking mechanism, e.g., a central bore 44 that includes one or more key ways 56. The key ways 56 have a desired cross-sectional contour, e.g., rectangular, which mate with the keys 38 on the shaft 36. When a plurality of key ways 56 is present, it provides an overall splined configuration in the central bore 44. Also, the finishing element 24 includes a top 58 and bottom surface 60 which are substantially perpendicular to the axis 46. When the radial keys 37 are present, corresponding radial slots (not shown) are on the underside surface 60 of finishing element 24. The bottom surface 60 nests on the planar surface of the dividing member 34.

An optional spacer, e.g., washer 62, may be positioned on the top surface 58 of the finishing element 24. An optional roller bearing 64 may be positioned on top of the washer 62. The roller bearing 64 acts as a guide during use of the finishing tool 20. The bearing enables the finishing distance to be spaced from the edge of the wood. The presence of the roller bearing 64 enables contact with the material, but prevents gouging and potential burning. The fastener 26 secures the finishing element 24, roller bearing 64, and washer onto the shaft 36. The threaded end 66 of the fastener 26 is received in the threaded bore 40 of the shaft 36.

Referring to FIG. 2A, in an alternate embodiment, a finishing tool 20′ is analogous to finishing tool 20 with common elements having the same reference numeral. Differences between finishing tool 20′ and finishing tool 20 include the locking mechanism that includes a shaft 36′ with a helical key 38′. The locking mechanism further includes a central bore 44′ with a corresponding helical key way 56′. Thus, the finishing element 24 can be attached to the shaft 36, via the helical key 38′ and key ways 56′, to secure the finishing element 24 against rotation on the drive tool 22. Generally, the helix would be wound in a direction opposite to the direction of rotation of the tool.

In other embodiments, the finishing element and the shank may be coupled in other ways. For example, the finishing element and shank may be integral with one another, may be attached using splines having different configurations, may be attached using one or more threaded fasteners, and/or may be attached using hook and loop fasteners. The shank may have a wide range of sizes (e.g., approximately ⅛ inch to 2 inches in diameter) so that the shank may be used with a wide range of rotary tools. The shank may also have a wide variety of cross-sections, for example, round, triangular, square, pentagonal, hexagonal, or octagonal. The finishing element and shank may incorporate a position locating feature, e.g., a POZI-STOP™ system manufactured by Porter-Cable.

FIG. 2B illustrates a rotary cutter 70 for use with the finishing tools 20 and 20′ described above. The rotary cutter 70 includes a shank portion 72 and a cutting head 74 with a roller bearing 76 and a fastener 78 to secure the roller bearing 76 to the cutting head 74. Note that the cutting head 74 has an exterior surface configuration or profile substantially similar to that of the finishing element 24. Thus, when the cutter bit 70 is used to cut a workpiece, forming a profile in the workpiece, the finishing element 24 can be positioned into the workpiece profile to sand, abrade, polish, or smooth the workpiece surface.

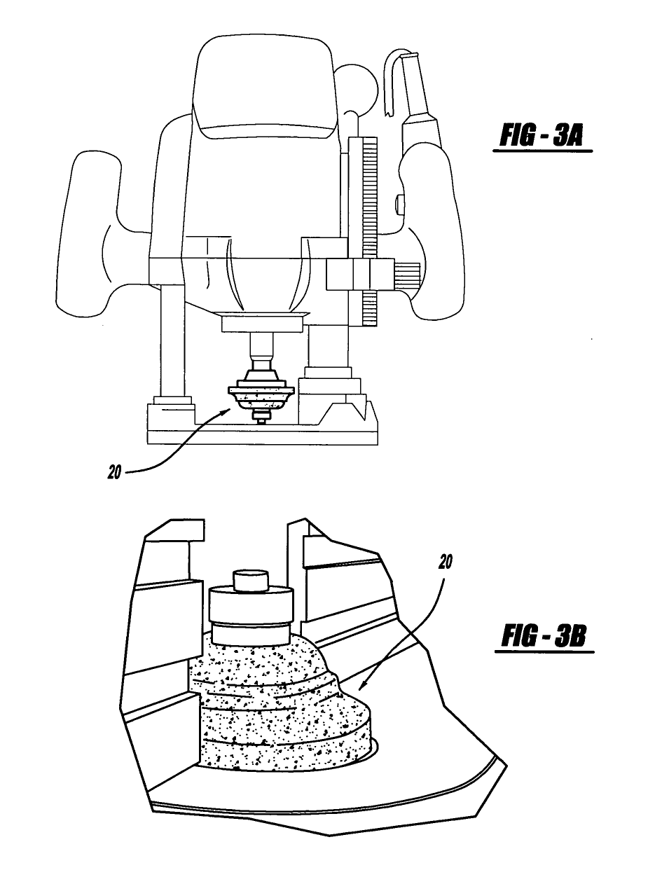

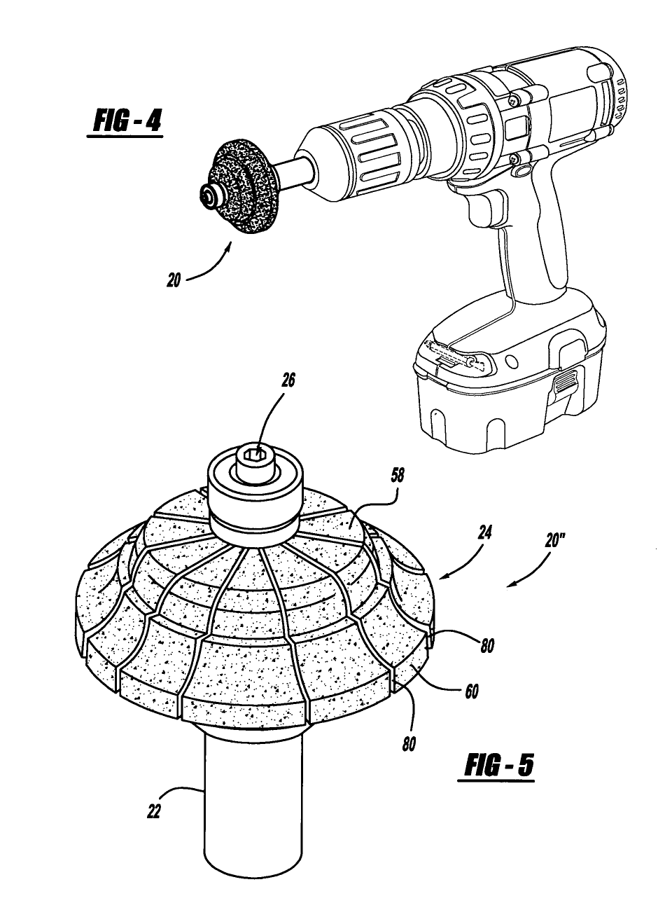

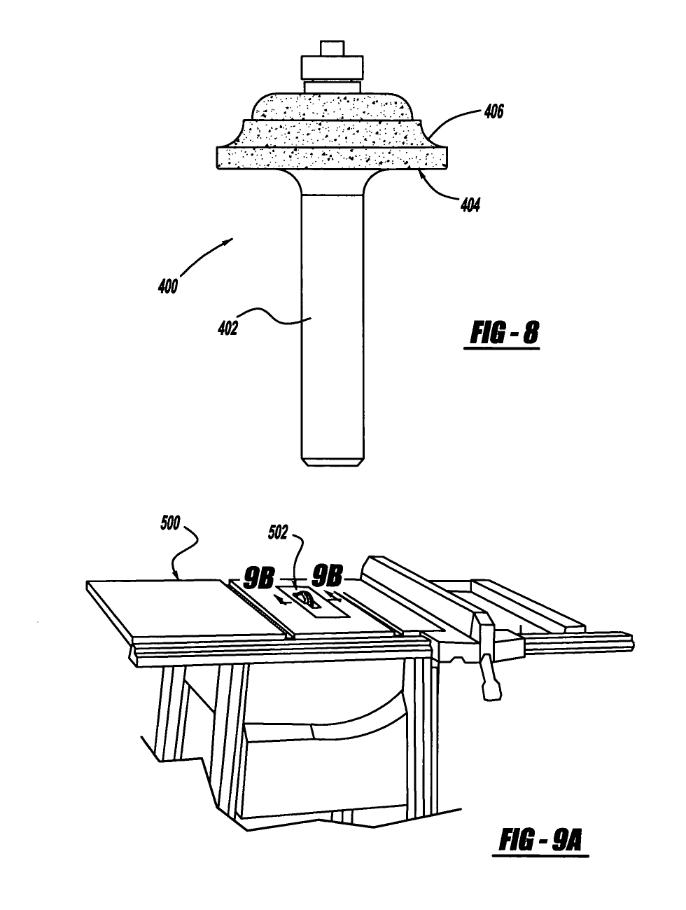

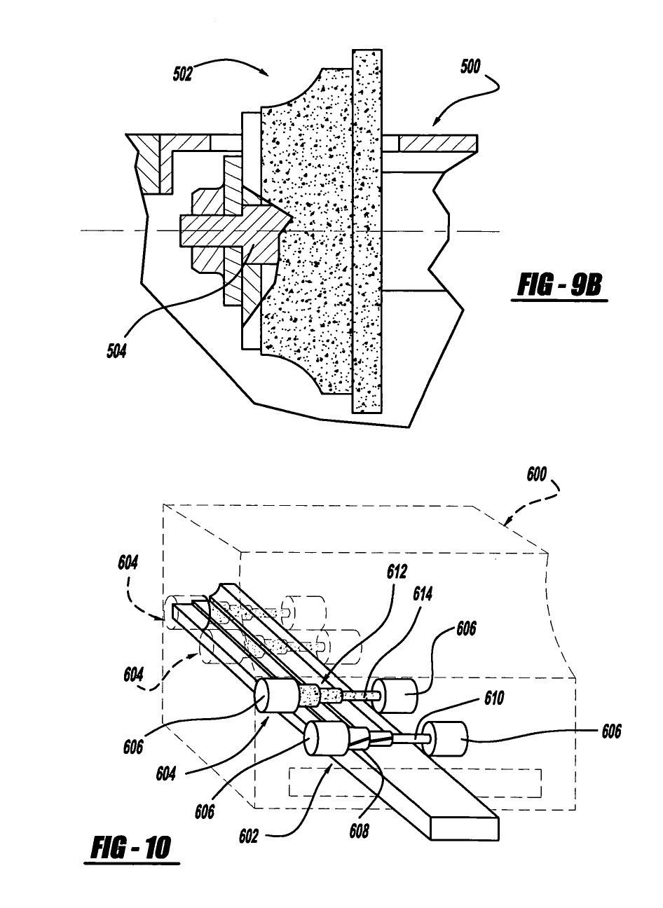

The various embodiments of a finishing tool can be coupled to a rotary drive mechanism, such as, for example, a router (FIG. 3A), a wood shaper (FIG. 3B), a drill (FIG. 4), a table saw (FIGS. 9A and 9B), a planer or moulder (FIG. 10), or a CNC machine tool. For example, in the embodiment shown in FIG. 3A, the drive tool shank 32 of finishing tool 20 is comprised of metal and the diameter of such shank 32 is one which is compatible with standard routers (i.e., one-fourth or one-half inches). This configuration enables the finishing tool 20 to be accepted into the same router to which the cutting tool is attached to remove the material. For example, in one embodiment, a spindle lock feature is present on the router collet to enable the cutting tool 70 and contoured finishing tool 20 to be changed easily with a single wrench. Other types of collet mechanisms could be used, e.g., a special collet that would alert the user to change the router speed or that has a spindle recognition feature. In an embodiment shown in FIG. 3B, the finishing tool is mounted to a wood shaper. In another embodiment shown in FIG. 4, the finishing tool 20 may be attached to a drill and used to finish a surface formed using a cutting tool that is attached to a router.

Additionally, the finishing tool 20 may be part of a kit or a single entity. As a kit, it provides a cutting tool 70 and corresponding finishing tool 20. Accordingly, the user would first make the desired cut by attaching the cutting tool 70 to the router, via the collet. Next, the user would remove the cutting tool 70 and insert the correspondingly shaped finishing tool 20. Thus, all cutting and abrading may be performed by the same rotary device. The finishing tool 20 may be used in conjunction with a variable speed router. This enables the user to use a high speed with the cutting tool 70 and a lower speed with the contoured finishing tool 20. A higher speed is used with the cutting tool 70 because such speed enables quicker removal of material. Also, the cutting tool 70 is sufficiently capable of distributing the heat and force associated with the work. In contrast, a lower speed is preferred with the contoured finishing tool 20. The lower speed inhibits the element from becoming too hot and burning, glazing, or burnishing the workpiece. In addition, the finishing tool may be available separate from its corresponding cutting tool in the event that additional finishing tools are required. Also, the kit may include a plurality of cutting tools and a plurality of corresponding finishing tools. The finishing tools may be removable so that only one drive tool is required.

Turning to FIG. 5, an additional embodiment of a finishing tool 20″ is shown. The elements which are the same as those described with FIG. 2 are identified with the same reference numeral. The differences between FIGS. 2 and 5 is that in FIG. 5, the finishing element 24 includes one or more debris channels 80. The debris channels 80 extend from the top surface 58 to the bottom surface 60 of the finishing element 24. The debris channels 80 may extend substantially parallel to the longitudinal axis 56 or, they may curve with respect to the axis (not shown). Channels 80 facilitate removal of debris or dust from the workpiece as the finishing tool is applied.

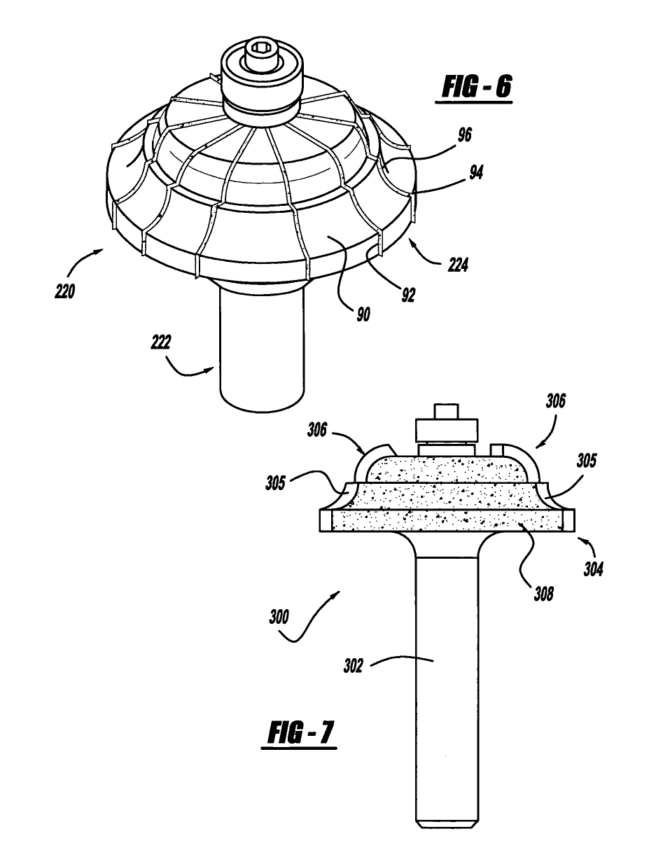

Turning to FIG. 6, an additional embodiment of a finishing tool 220 is shown. Finishing tool 220 includes a finishing element 224 attached to a coupling shaft 222 in a manner analogous to finishing tool 20 described above. Finishing element 224 has an outer surface with a profile analogous to the profile of finishing element 24, which is substantially inverse to the profile of the surface to be finished and/or which substantially matches the profile of the corresponding cutting element that is used to form the surface. The finishing element 224 may be formed from a semi-rigid or rigid material and includes a body 90 having a plurality of slots 92 formed into the body 90. Slots 92 are shown as being generally parallel to the longitudinal axis, but may be, e.g., angled and/or curved. A plurality of flexible abrasive inserts 94 are received in the slots 92 of the body 90. The inserts 94 have an external surface 96 formed from an abrasive material such as abrasive cloth or plastic or the like with a grit surface on the insert. The slots cause the surface 96 of the insert 94 to conform to the contoured profile of the finishing element 224. Thus, the insert is flexible to enable the finishing element 224 to finish the workpiece, e.g., by sanding, abrading, polishing or smoothing the workpiece surface.

Turning to FIG. 7, in an additional embodiment, a tool 300 includes a shank portion 302, a toroidal shape body portion 304 with one or more cutting members 306 and one or more finishing members 308 that are contoured to form a desired profile in a workpiece. Each cutting member 306 includes one or more contoured cutting blades 305 that cut the workpiece during rotation of the tool. Each finishing member 308 is positioned between the cutting blades 305. Each finishing member 308 generally has a similar profile to the cutting blade 305, and may have an outer diameter that is less than, greater than, or equal to the diameter of the cutting blades. After the cutting blade 305 cuts the workpiece, the finishing member 308, via its abrasive surface, finishes the surface, e.g. by sanding, abrading, polishing or smoothing the surface. The abrasive surface may be formed by any manner discussed above, including, for example, by bonding to the body. Thus, the tool 300 cuts and finishes the workpiece as the tool is rotated.

Referring to FIG. 8, in an additional embodiment, a finishing tool 400 includes a shank portion 402 and a body portion 404. The shank and body portions 402, 404 are generally unitarily formed from a material, such as a metal material. An abrasive medium, such as grit or the like, is bonded to the body portion 404. The body portion 404 has an exterior surface 406 which has a desired configuration like that described above. Here, the shank 402 and body portion 404 is a one piece unit.

Turning to FIGS. 9A, 9B, and 10, in additional embodiments, the profiled finishing tool can be modified to fit other types of rotary tools. In FIGS. 9A and 9B, a finishing element 502 is illustrated for use on the arbor 504 of a table saw 500. Finishing element 502 includes a central bore adapted to fit the arbor of a table saw. Finishing element 502 has an exterior surface with a profiled configuration that is substantially the inverse of the profile of the surface of a workpiece and/or that is substantially the same as the profile of the table saw cutting tool used to form the surface.

In FIG. 10, a finishing element is illustrated for use on a planer or moulder 600. In this embodiment, a cutting head 602 and finishing head 604 are simultaneously coupled to the planer 600. As the workpiece is fed through the planer, the rotating cutting head 602 cuts a profiled surface on the workpiece, and the profiled finishing head 604 finishes the surface, e.g., by sanding, abrading, polishing or smoothing the surface. A pair of shank members 606 are on each side of the cutting member 608. A shaft 610 projects between the shanking members 606. The finishing element 612 is secured to a shaft 614 to finish the workpiece after the workpiece had been cut. In another embodiment, a plurality of finishing heads (shown in phantom), perhaps with varying grain sizes, could be used arranged in series in a planer or moulder.

The above description is merely exemplary in nature. Other features and embodiments are within the scope of the following claims.

What is claimed is:

1. A device for finishing a surface comprising:
a body member having a contoured exterior surface, the body member being adapted for coupling with a shaft;
at least two surface portions defining said contoured exterior surface, said at least two surface portions positioned at different radial distances from said axis; and
an abrasive member on said at least two surface portions for finishing a surface.

2. The device of claim 1, wherein the body member has a generally toroidal shape.

3. The device of claim 1, wherein the body member comprises a central bore adapted for coupling with the shaft.

4. The device of claim 1, wherein said body member comprises a rigid or semi-rigid material.

5. The device of claim 4, wherein said semi-rigid material comprises one or more of foam, metal fiber, composite fiber, plastic, felt, rubber, and polymers.

6. The device of claim 1, wherein the abrasive member comprises an abrasive grit coupled to the body member.

7. The device of claim 6, wherein the abrasive grit is impregnated in the body member.

8. The device of claim 1, wherein the body member comprises one or more slots and the abrasive member comprises one or more flexible abrasive flaps received in the one or more slots.

9. A device for finishing a surface comprising:
a body portion having an exterior surface configured to finish a surface formed by a rotary cutter, the exterior surface having a profile that substantially corresponds to a portion of a profile of a surface formed by the rotary cutter; and
a coupling member coupled to the body portion and adapted to be coupled to a rotary drive mechanism to transmit rotational energy to the body portion.

10. The device of claim 9, wherein the body portion has a profile that is substantially inverse to the profile of the cut surface.

11. The device of claim 9, wherein the body portion further comprises an abrasive material on said exterior surface.

12. The device of claim 11, wherein the abrasive material is semi-rigid.

13. The device of claim 11, wherein the abrasive material is coupled to an underlying substrate.

14. The device of claim 13, wherein the substrate comprises foam

15. The device of claim 9, wherein the body portion further comprises one or more channels configured to facilitate removal of debris from the surface.

16. The device of claim 9, wherein the body portion comprises one or more slots configured to receive one or more abrasive elements.

17. The device of claim 9, wherein the body portion is configured to sand, abrade, polish or smooth the surface.

18. The device of claim 9, wherein the body portion comprises a rigid or semi-rigid material.

19. The device of claim 18, wherein the body portion is unitarily formed with the shaft.

20. The device of claim 9, wherein the coupling member comprises a locking mechanism.

21. The device of claim 20, wherein said locking mechanism comprises a bore with at least one key way for coupling with a shaft of a rotary drive mechanism.

22. The device of claim 21, wherein the locking mechanism further comprises a plurality of key ways forming a spline pattern in the bore.

23. The device of claim 20, wherein said at least one key way has a helical configuration.

24. The device of claim 9, further comprising a drive tool having a shaft having at least one key for mating with a key way in said bore, and said drive tool having a shank for coupling with a rotary device such as a router or drill.

25. The device of claim 9, said bore coupling with an arbor of a table saw.

26. The device of claim 9, further comprising a drive tool having a shaft for driving said finishing element and said drive tool having two shanks, one at each end of said shaft for coupling with a planer or moulder.

27. A device for cutting and finishing a surface comprising:
a body portion having a cutting member, said cutting member having a desired configuration for forming a cut profile in a workpiece; a finishing member on said body portion, said finishing member having a desired configuration substantially similar to said cutting member for finishing the cut profile; and
a coupling member coupled with the body portion and adapted to be coupled to a rotary drive mechanism

28. The device of claim 27, wherein the cutting member comprises at least two cutting blade.

29. The device of claim 27, wherein the cutting blades each have a profile that is substantially inverse to the desired profile cutting workpiece.

30. The device of claim 27, wherein the finishing member comprises one or more abrasive surfaces disposed between the cutting blade.

31. The device of claim 27, wherein the abrasive surface has an outer diameter that is less than an outer diameter of the cutting blade.

32. A method of forming a surface, the method comprising:
cutting a desired profile into a surface of a workpiece using a first rotary tool coupled to a cutting device, the cutting device having a profile that is substantially inverse to the desired profile of the surface; and
finishing the profile surface of the workpiece using a second rotary tool coupled to a finishing element, the finishing element having a profile that is substantially inverse to the desired profile of the surface of the workpiece.

33. The method of claim 32, wherein the first rotary tool is a router and the second rotary tool is a drill.

34. The method of claim 32, wherein the cutting device comprises a router bit and the finishing element comprises a finishing bit.

35. The method of claim 32, wherein the first and second rotary tools are the same.

36. A kit comprising:
a rotary cutting tool for cutting a profile in a surface of a workpiece;
a finishing tool having a finishing element configured to finish the surface of the workpiece formed using the cutting tool, the finishing element having a profile that substantially corresponds to a profile of the surface of the workpiece; and
a coupling member coupled with the body portion and adapted to be coupled to a rotary drive tool to transmit rotation energy to the finishing element.

37. The kit of claim 36, further comprising a plurality of cutting and finishing tools.

38. The kit of claim 37, wherein each of said plurality of cutting and finishing tools has a different contour surface with each cutting tool having a corresponding substantially similar finishing tool.

39. The kit of claim 38 wherein the cutting and finishing tools are interchangeable.
